(19) United States
(12) Patent Application Publication
(10) Pub. No.: US 2014/0331570 A1
(43) Pub. Date: Nov. 13, 2014

(54) AIR BEARING TRANSPORT SYSTEM

(71) Applicant: TSC OFFSHORE CORPORATION, Houston, TX (US)

(72) Inventors: Scott Bradford FULLERTON, Houston, TX (US); John E. MCLEAN, JR., Houston, TX (US)

(73) Assignee: TSC OFFSHORE CORPORATION, Houston, TX (US)

(21) Appl. No.: 14/107,472

(22) Filed: Dec. 16, 2013

Related U.S. Application Data
(60) Provisional application No. 61/822,768, filed on May 13, 2013.

(51) Int. Cl. B60V 1/14; E21B 7/02

(52) U.S. Cl. CPC B60V 1/14; E21B 7/02
USPC 52/143; 180/119

(57) ABSTRACT

An air bearing transport apparatus has a support structure coupled to a plurality of traction units. The traction units are tracks that are rotationally coupled to the support structure and independently steerable. Each traction unit is coupled to the support structure by a linear actuator that acts as a normal force applicator to prevent slippage. A plurality of thrusters in a lower portion of the support structure provides a gas flow substantially perpendicular to a support surface of the support structure to provide an upward force on the support structure. The air bearing transport apparatus may be used with a portable modular surface comprising interlocking tiles.

### CROSS-REFERENCE TO RELATED APPLICATIONS

This application claims benefit of U.S. Provisional Patent Application Ser. No. 61/822,768 filed May 13, 2013, which is incorporated herein by reference.

### FIELD

Embodiments described herein relate to a bearing system for very heavy objects, such as drilling rigs. More specifically, the present disclosure relates to an air bearing transport system for transporting heavy objects over prepared ground.

### BACKGROUND

Production of oil and gas is a trillion dollar industry. Producers continually seek ways to increase the speed and flexibility, and lower the cost of, production apparatus for onshore and offshore oil and gas production. Onshore, drilling rigs and support units must be disassembled into pieces that can be transported by truck to a new site or between wells on a single site (pad drilling). Such procedures can take up to three or four days. Thus, there is a continuing need for drilling apparatus that can be moved quickly and efficiently from one drill site or well to another.

### SUMMARY

Embodiments disclosed herein provide an air bearing transport system with a support structure having a support surface, a plurality of thrusters coupled to the support structure, each thruster producing a gas flow in a direction substantially perpendicular to the support surface, and a plurality of traction units rotatably coupled to a peripheral region of the support structure, each traction unit comprising a track member. The air bearing transport system can be used to support a drill rig, precisely position the drill rig over a bore hole, and move the drill rig from one site to another. Each of the traction units is coupled to the support structure by a rotation assembly and a normal force applicator, and each of the traction units is independently steerable. The traction units can be controlled and synchronized to operate in various combinations and configurations.

Other embodiments described herein include a portable surface that may be used with an air bearing transport system. The portable surface is modular, so the shape of the portable surface may be adjusted, and the portable surface may be dynamically positioned in the direction of movement of the air bearing transport system.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a side view of a drilling rig supported by an air bearing transport apparatus according to one embodiment.

FIG. 2A is a perspective view of a traction unit of the air bearing transport apparatus of FIG. 1.

FIG. 2B is a close-up cross-sectional view of a portion of the traction unit of FIG. 2A.

FIG. 2C is a side view of the traction unit of FIG. 2A.

FIG. 2D is a side view of a traction unit of an air bearing apparatus according to another embodiment.

FIG. 2E is a side view of a traction unit of an air bearing apparatus according to another embodiment.

FIG. 2F is a perspective view of a traction unit of an air bearing apparatus according to another embodiment.

FIG. 2G is a side view of the traction unit of FIG. 2F.

FIG. 3 is a top view of the air bearing transport apparatus of FIG. 1.

FIG. 4A is a top view of a drilling system according to another embodiment.

FIG. 4B is a top view of two interlocking tiles according to another embodiment.

FIG. 4C is a cross-sectional view of the interlocking tiles of FIG. 4B.

FIG. 4D is a cross-sectional view of a portable surface according to another embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

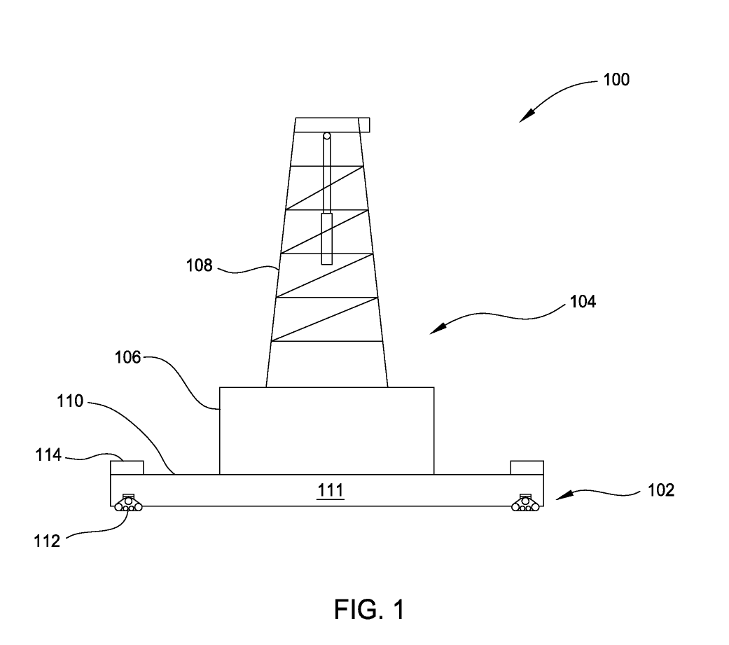

FIG. 1 is a side view of a drilling apparatus 100 with a drilling rig 108 supported by an air bearing transport apparatus 102 according to one embodiment. The air bearing transport apparatus 102 enables the drilling rig 108 to be transported on prepared ground at a drilling site without need for pavement or matting. A sub-base unit 106 of the drilling rig 108 rests on a support structure 111 of the air bearing transport apparatus 102 with a support surface 110. The air bearing transport apparatus 102 has thrusters that produce a force substantially perpendicular to the support surface 110, enabling the drilling apparatus 100 to float on a cushion of gas. Traction units 112 are coupled to the support structure 111 to provide lateral movement of the air bearing transport apparatus 102 to move the drilling rig 108. The air bearing transport apparatus 102 may be used to transport any large and/or heavy object without the need for matting or pavement, if the surface is substantially free of cracks, fissures, holes, or other kinds of openings that may compromise lift from the air bearing.

The traction units 112 may be independently steered to maneuver the cargo on the support structure 111. In the case of a drilling rig, the traction units 112 enable precise alignment of the drilling rig 108 and sub-base unit 106 with a target drilling spot, such as a pre-installed drill casing. Independent operation of the traction units 112 enable rotation of the drilling rig 108 and sub-base unit 106 in place to provide positioning that may be needed to access the target drilling spot, or positioning that may be needed for connectivity of drilling infrastructure such as power, fluids processing, and equipment handling. The traction units 112 may be powered by individual power units 114, each power unit 114 coupled to a traction unit 112.

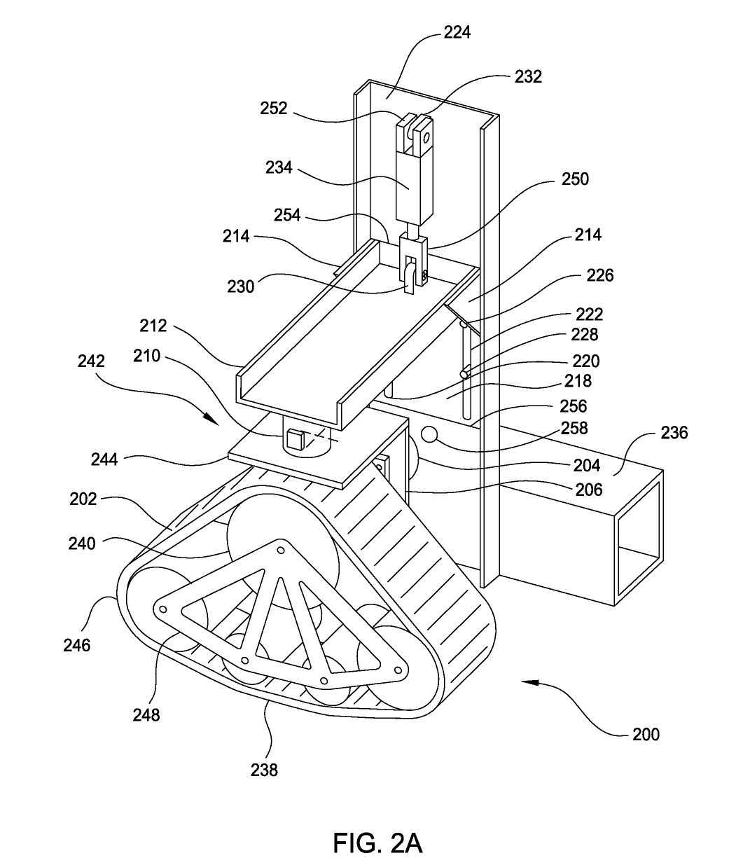

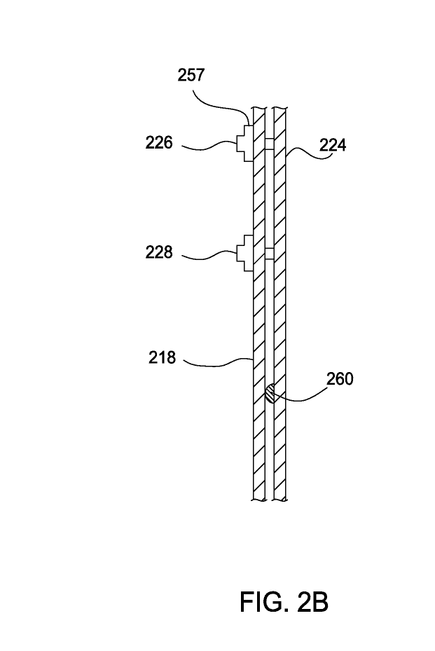

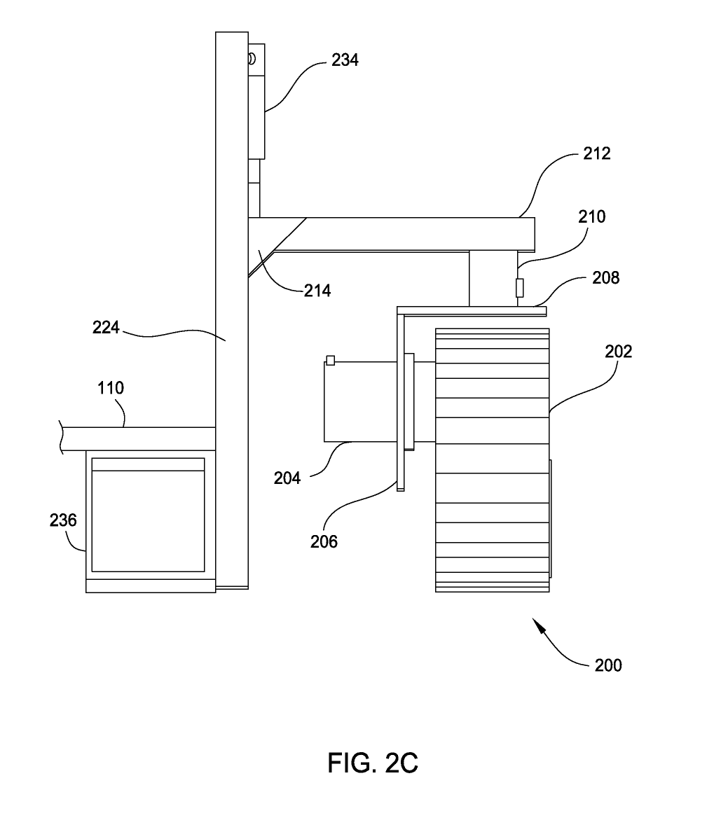

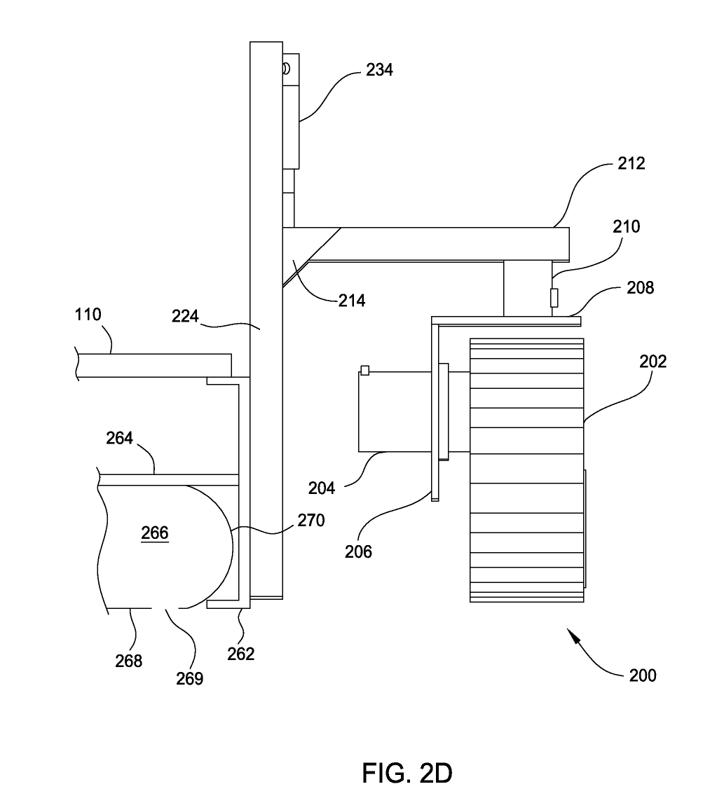

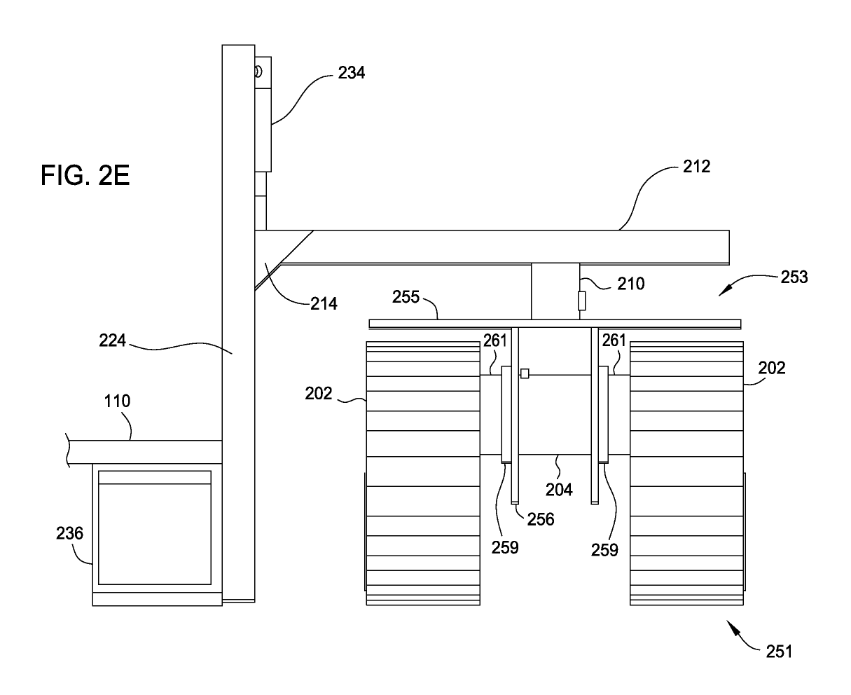

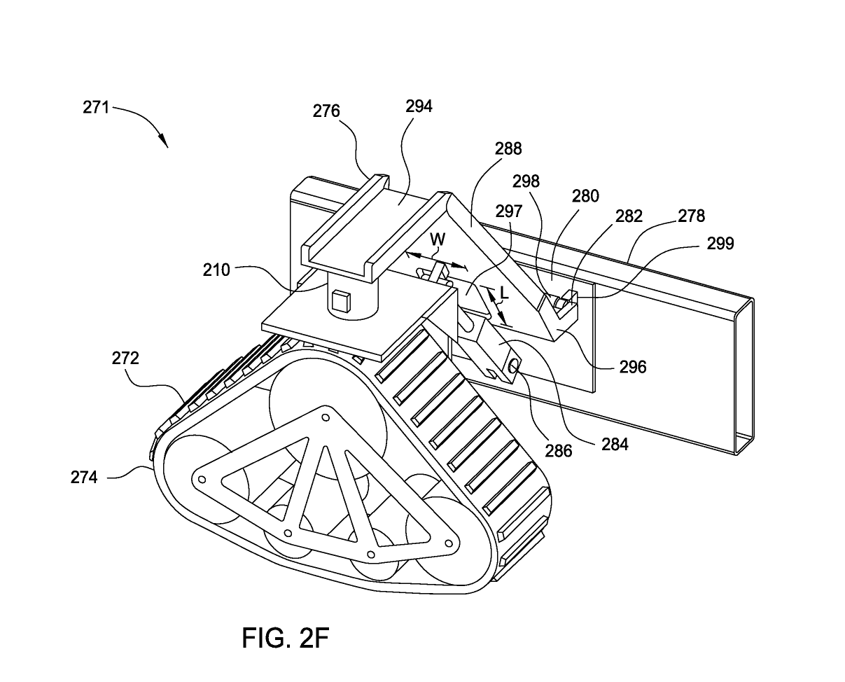

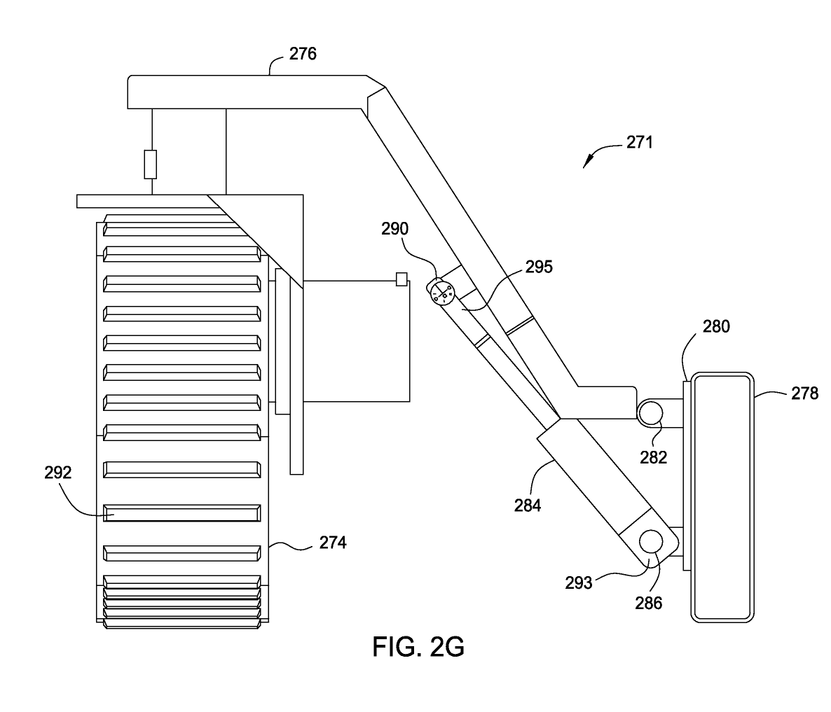

FIG. 2A is a perspective view of a traction unit 200, according to one embodiment, that may be used with the air bearing transport system 102 (i.e. each of the traction units 112 may be a traction unit 200) of FIG. 1. The traction unit 200 has a track member 202 that contacts a surface at a contact portion 238 so that a frictional force produces a lateral thrust on the track member 202. The track member 202 has a motor 204 that actuates a drive rotor 240 of the track member 202. The drive rotor 240 circulates a track 246 around a roller frame 248.

The track member 202 is coupled to the traction unit 200 by a rotation assembly 242. The rotation assembly 242 couples the track member 202 to a lateral support 212, which maintains the track member 202 and the rotation assembly 242 in a position spaced apart from a track support 224 allowing free rotation of the track member 202. The track support 224 is coupled to a frame member 236 that is attached to the support structure 111 (FIG. 1). The frame member 236 is a part of the support structure 111 that supports the support surface 110.

The rotation assembly 242 has a motor support 206, which is disposed around the motor 204. An extension 244 of the motor support 206 extends over the track member 202 to a location that encompasses an axis of rotation of the track member 202, which may be a central axis of the track member 202. A rotary actuator 210 is coupled to the motor support 206 along the axis of rotation. The rotary actuator 210 may be attached to the extension 244, and may comprise a rotor attached to the extension 244 and a stator attached to the lateral support 212.

The lateral support 212 has an extent that allows the track member 202 to rotate without either the motor 204 or the track 246 contacting the track support 224 or the frame member 236. The lateral support 212 is coupled to a slide plate 218 that mates with a channel of the track support 224. The slide plate 218 is slidably coupled to the track support 224, and may be attached to the lateral support 212 by bracers 214. The slide plate 218 has at least two slots 222, each of which receives at least two rods, an upper rod 226 and a lower rod 228. The upper and lower rods 226/228 guide motion of the slide plate 218 along the track support 224 and limit the range of motion of the slide plate 218. There is a bracer 214, slot 222, upper rod 226, and lower rod 228 on the left and right side of the slide plate 218. As the slide plate 218 moves down along the track support 224, an upper limit of the slot 222 contacts the upper rod 226, and the downward motion of the slide plate 218 stops. Likewise, as the slide plate 218 moves up along the track support 224, a lower limit of the slot 222 contacts the lower rod 228, and the upward motion of the slide plate 218 stops. Thus, the range of motion of the slide plate 218, and by extension of the track member 202, may be selected by defining dimensions of the slide plate 218, the slots 222, and spacing of the upper and lower rods 226/228.

The lateral support 212 may be coupled to the slide plate 218 at an upper end 254 of the slide plate 218, as shown in FIG. 2A, at a lower end 256 of the slide plate 218, or between the upper end 254 and the lower end 256 of the slide plate 218. If the lateral support 212 is coupled to the slide plate 218 at the upper end 254, the slots 222 and rods 226/228 will be below the lateral support 212. If the lateral support 212 is coupled to the slide plate 218 at the lower end 256, the slots 222 and rods 226/228 will be above the lateral support 212. If the lateral support 212 is coupled to the slide plate 218 between the upper end 254 and the lower end 256, the slots 222 may be above or below the lateral support 212, or the slots 222 may traverse the coupling location of the lateral support 212 such that the upper limit of the slot 222 is above the lateral support 212 and the lower limit of the slot 222 is below the lateral support. In such an embodiment, the upper rod 226 may be above the lateral support 212 while the lower rod 228 is below the lateral support 212. Also, in such an embodiment, the rods 226/228 on the left and right sides of the slide plate 218 may be located such that motion of the slide plate 218 is limited by one or both of the rods 226/228 contacting the lateral support 212, rather than a limit of the slots 222, if desired.

Motion of the slide plate 218 may be actuated by a linear actuator 234 coupled to the lateral support 212, the slide plate 218, or both. The linear actuator 234, which may be hydraulic ram, is coupled by a first coupling 230 at a first end 250 of the linear actuator 234 and a second coupling 232 at a second end 252 of the linear actuator 234. Each of the first and second couplings 230/232 may have one or more rotational degrees of freedom, if desired, to manage stresses on the linear actuator 234.

The lateral support 212 may have a channel configuration to provide shear strength for supporting the weight of the track member 202 and rotation assembly 242. The track support 224 may also have a channel configuration for shear stability, and to provide a channel to guide movement of the slide plate 218. Contact surfaces of the slide plate 218 and the track support 224 may be coated with an anti-friction coating, such as teflon, if desired, to reduce power requirements and wear on parts. The channels of the lateral support 212 and the track support 224 have depth selected based on the mechanical strength requirements for supporting the track member 202. In the embodiment of FIG. 2A, the channel of the lateral support 212 is 3 inches deep and the channel of the lateral support 224 is 3 inches deep. The channel depth may be selected to provide any specified strength. Deeper channels provide more mechanical strength to support more weight.

FIG. 2B is a cross-sectional detail of a portion of the traction unit 200 of FIG. 2A. The track support 224 is shown in cross-section, along with the slide plate 218. The upper and lower rods 226/228 are seen extending from the track support 224 through the slide plate 218. One or more of the upper and lower rods 226/228 may have a collar 257 that limits motion of the slide plate 218 away from the track support 224, if desired. The lever arm of the track member 202 will typically produce a moment that will tend to pull the slide plate 218 away from the track support 224. This moment may be countered by the linear actuator 234 alone, or the collar 257 on one or both of the upper and lower rods 226/228 may partly counteract the moment, absorbing some of the force and reducing stress on the linear actuator 234. If a collar 257 is provided on one or more of the upper and lower rods 226/228, one or more bearings 260 may also be provided at convenient locations to counteract the rotational moment that may be imparted to the slide plate 218. The bearings 260 may be ball bearings or roller (cylindrical) bearings seated in an opening in the slide plate 218 shaped to hold the bearings in place. The opening may have a depth slightly less than a diameter of a bearing 260 disposed in the opening so that a portion of the bearing protrudes beyond a surface of the slide plate 218. The portion of the opening through which the bearing protrudes may have a dimension less than the diameter of the bearing to retain the bearing in the opening.

If a collar 257 is provided on the upper and lower rods 226/228 in each of the slots 222, an opening 258 may be provided through the track support 224 to install a peg for parking the slide plate 218 so that the linear actuator 234 may be removed or replaced. The combination of the peg through the opening 258 with the collars 257 on the rods 226/228 hold the slide plate 218, the track member 202, and the rotation assembly 242 in place until the linear actuator 234 is restored to service.

FIG. 2C is a side view of the traction unit 200 of FIG. 2A. The lateral support 212 is visible extending from the track support 224 (the slide plate 218 is hidden by the track support 224 in FIG. 2C). A bracer 214 is shown connecting the lateral support 212 to the slide plate 218 (FIG. 2A). The bracer 214 is a triangular connector in FIG. 2C, and may have any convenient or desired angular properties. The bracers 214 may be equilateral triangles, isoceles triangles, or scalene triangles. The bracers 214 may also be non-triangular shapes, such as rectangles and squares. The bracers 214 may also be non-rectangular parallelograms, such as rhombuses. The bracers 214 are typically welded to the slide plate 218 and the lateral support 212, but they may be bolted to the slide plate 218 or the lateral support 212, or both, instead of, or in addition to, being welded.

The track support 224 is fastened to the frame member 236 by welds, bolts, or pins, depending on the desired load capacity. As shown in FIG. 2C, the frame member 236 supports the support surface 110, and may have air bearing thrusters disposed at a lower surface thereof to provide lift to the support surface 110. Configuration of the track support 224 with respect to the support surface 110 in this way provides capability to raise the traction unit 200 off the ground (or other rolling surface) to rotate the traction unit 200 without friction.

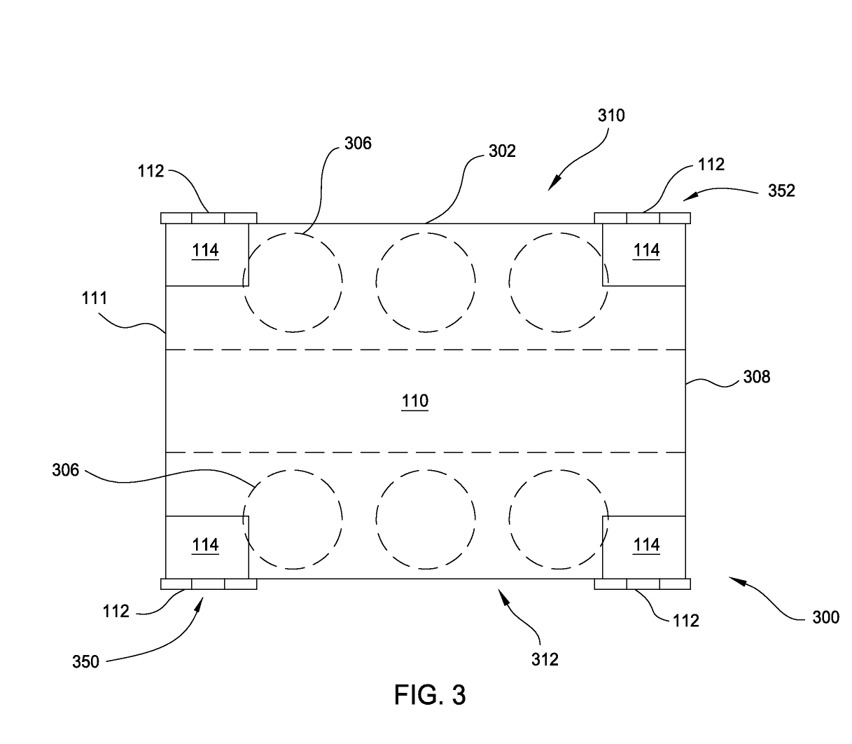

FIG. 2D is a side view of the traction unit 200 coupled to an air bearing apparatus according to another embodiment. The track support 224 is attached to a channel member 262 in FIG. 2D. The channel member 262 supports the support surface 110. A plate 264, with the channel member 262, defines a space for a gas nozzle 266. The gas nozzle 266 has a side 270 that is flexible, and a lower extremity 268 of the gas nozzle 266 has one or more openings 269 that allow gas to escape, providing an upward force on the plate 264 that supports the support surface 110. Gas is flowed into the gas nozzle 266, which inflates the flexible side 270 of the gas nozzle. The openings 269 have a diameter that enables maintaining a pressure in the gas nozzle 266, resulting in the upward force on the support surface 110. The gas nozzle 266 is an embodiment of a thruster, discussed further below in connection with FIG. 3.

FIG. 2E is a side view of a traction unit 251 coupled to an air bearing apparatus according to another embodiment. In the embodiment of FIG. 2E, the track member is a dual track member 253 comprising two track members 202 coupled to the motor 204 by an axle 261 and a coupling 259 coupling 259 through a support 255. The rotary actuator 210 couples the support 255 to the lateral support 212 and provides the capability to turn the dual track member 253 to steer the air bearing apparatus.

FIG. 2F is a perspective view of a traction unit 271 coupled to an air bearing apparatus according to another embodiment. The traction unit 271 is coupled to a support frame 278 of the air bearing apparatus, for example a side member of the support structure 111 of FIG. 1 by an attachment plate 280, which may be welded, bolted, or otherwise suitably attached to the support frame 278. The traction unit 271 is coupled to the attachment plate 280 by a cantilever member 276. The rotary actuator 210 is coupled to a connection span 294 of the cantilever member 276 by any suitable attachments means, such as bolting or welding. The connection span 294 is coupled to an angle span 288, which is in turn coupled to a hinge portion 296. The hinge portion 296 of the cantilever member 276 is coupled to the attachment plate 280 by a hinge 282 of any suitable type. In the embodiment of FIG. 2F, the hinge 282 comprises a dowel 298 that attaches to the hinge portion 296 at both ends of the dowel 298 (only one end of the dowel 298 is visible in the perspective view of FIG. 2F), and couples to a rotation bracket 299 that allows the cantilever member 276 to rotate about the dowel 298. Rotation of the cantilever member 276 is actuated by a hydraulic actuator 284, which is attached to the attachment plate 280 by a hinge 286.

FIG. 2G is a side view of the traction unit 271 of FIG. 2F. The hydraulic actuator 284 is attached to the attachment plate 280 at a first end 293 of the hydraulic actuator 284 and to the cantilever member 276 at a second end 295 of the hydraulic actuator 284. The hydraulic actuator 284 is attached to the cantilever member 276 by a hinge 290. The hinges 282, 286, and 290 allow the hydraulic actuator 284 to rotate the cantilever member 276 about the hinge 282, raising and lowering the traction unit 271 as needed and applying downward force to the traction unit 271 to provide friction between the track 274 of the traction unit 271 and a surface on which the track 274 is deployed. The hydraulic actuator 284 may be a double-port piston to allow force application in either direction along the linear extent of the hydraulic actuator 284. Thus, the hydraulic actuator 284 may apply an extension force to grow longer and raise the traction unit 271, or the hydraulic actuator 284 may apply a retraction force to grow shorter, lower the traction unit 271, and apply a downward force to the traction unit 271.

As the hydraulic actuator 284 extends, the traction unit 271 rises, and the second end 295 of the hydraulic actuator 284 moves toward the support member 278. Referring again to FIG. 2F, a slot 297 is provided in the angle span 288 of the cantilever member 276 to accommodate motion of the hydraulic actuator 284 toward the support member 278 while eliminating the possibility that the hydraulic actuator 284 may undesirably contact the cantilever member 276. The slot has a width “W” that is greater than a maximum width of the hydraulic actuator 284 to provide clearance for the actuator 284. The slot 284 has a length “L” sufficient to avoid contact with the hydraulic actuator 284 at its maximum extent. Although not shown in the embodiment of FIG. 2F, the slot 297 may extend from the angle span 288 into the hinge portion 296, if desired, to allow clearance for the hydraulic actuator 284.

Referring again to FIG. 2G, the track 274 has a plurality of cleats 292 to promote friction with the surface on which the track 274 is deployed. The cleats 292 of FIG. 2G have the shape of a regular trapezoidal solid to provide tapered surfaces on all sides of each cleat 292. The tapered surfaces promote release of each cleat from the underlying surface as the cleat disengages from the surface, reducing rolling resistance and force necessary to raise the traction unit 271 above the surface. The dimensions of the cleats may be adjusted to accommodate any surface type from a hard smooth surface to a soft muddy surface. If desired, the tracks may be given an irregular trapezoidal solid shape to increase application of friction to the surface and/or penetration into the surface. Other shapes, such as a triangular solid shape, a rounded triangular solid shape, a rectangular solid shape, or a rounded rectangular solid shape, may also be used.

FIG. 3 is a top view of an air bearing transport apparatus 300 according to one embodiment. The apparatus 300 is similar to the air bearing transport apparatus 102 of FIG. 1. The apparatus 300 has the support structure 111 with the support surface 110, a plurality of the traction units 112 (or 200 or 250) positioned at the corners of the support structure 111, and the power units 114 positioned near the traction units 112. In one embodiment, the plurality of traction units may be two traction units positioned at diagonally opposite locations, such as 350 and 352, of the support structure 111. A plurality of thrusters 306 is arranged to direct a flow of gas substantially perpendicular to the support surface 110. The plurality of thrusters 306 is located in a lower portion of the support structure 111 under the support surface 110 so that the gas flow from the thrusters 306 creates a cushion of gas, for example air, on which the support structure 111 rests. As noted above, the thrusters 306 may be attached to a lower portion of the frame member 236 (FIGS. 2A, 2C).

The plurality of thrusters 306 in FIG. 3 is arranged in a first thruster group 310 and a second thruster group 312, each thruster group arranged in a row parallel to an axis of the support structure 111. The first and second thruster groups 310/312 are separated by a gap 308 that provides access space between the thruster groups through the support structure 111, if desired. For example, the support surface 110 may feature openings to allow operation of the drilling rig 108 of FIG. 1 through and between the thruster groups 310/312 to the ground below. The plurality of thrusters 306 may be arranged according to any convenient pattern. Gas may be provided to the thrusters 306 by a single compressor or blower, or multiple compressors and/or blowers may be used. The compressor may be positioned on the support surface 110 or may be positioned adjacent to the support surface 110, for example on a truck that travels beside the support surface 110. The thrusters 306 in FIG. 3 are depicted as having a circular profile, but any convenient and suitable profile may be used. The thrusters 306 may be nozzles, ducts, pipes, or any combination thereof, and may have circular, square, or rectangular profiles, or any other suitable profile.

In operation, the plurality of thrusters 306 delivers a force perpendicular to the support surface 110 enabling the support structure 111, and any object or cargo positioned on the support surface 110 to be supported on a gas cushion. The linear actuators 234 are extended until the traction units 112 are loaded with sufficient normal force to provide enough friction so the tracks 202 (FIGS. 2A-2E) do not slip when the track members are powered. The traction units 112 are typically provided with a force sensor coupled to the tracks or to the linear actuator. In embodiments wherein the linear actuator 234 is hydraulic, the force sensor may be a pressure sensor coupled to the hydraulic medium. The normal force on each traction unit 112 is typically equalized. Gas, for example air, is typically provided to the thrusters 306 by a compressor, or compressor assembly, that may be inboard on the apparatus 300, for example on the support surface 110 or disposed within the substructure below the support surface 110. Alternately, the compressor or compressor assembly may be outboard, for example on a truck or trailer that stations beside the apparatus 300 while in operation and connects to the apparatus 300 through hoses, lines, or ducts.

The air bearing support apparatus 102 may be steered using the rotation assembly 242 of each traction unit 200 (or by operation of the rotary actuator 210 in the traction unit 251), and by differentially powering the traction units on one side of the apparatus 102. Incremental steering and tracking may be performed while the tracks 202 are in contact with the ground or another surface. More pronounced steering, such as cornering or other more abrupt direction-changing may be performed by retracting the linear actuators 234 to lift the tracks 202, and then rotating the tracks 202 to a new position to steer in a new direction. The tracks 202 are then lowered by extending the linear actuators 234, force-equalized, and powered to move the cargo in a different direction.

The apparatus 102 may be used to precisely position the cargo for an operation to be undertaken above the support surface 110 or below the support surface 110. In the example of a drilling rig, a drill bore is often initiated before the rig is deployed, so the rig must be positioned precisely to place a drill string in the pre-bored hole. The drill rig 108 positioned on the air bearing transport system 102 may be positioned in an x-y plane to a precision of about 1 mm by rotating the traction units 112 and incrementally advancing the traction units 112.

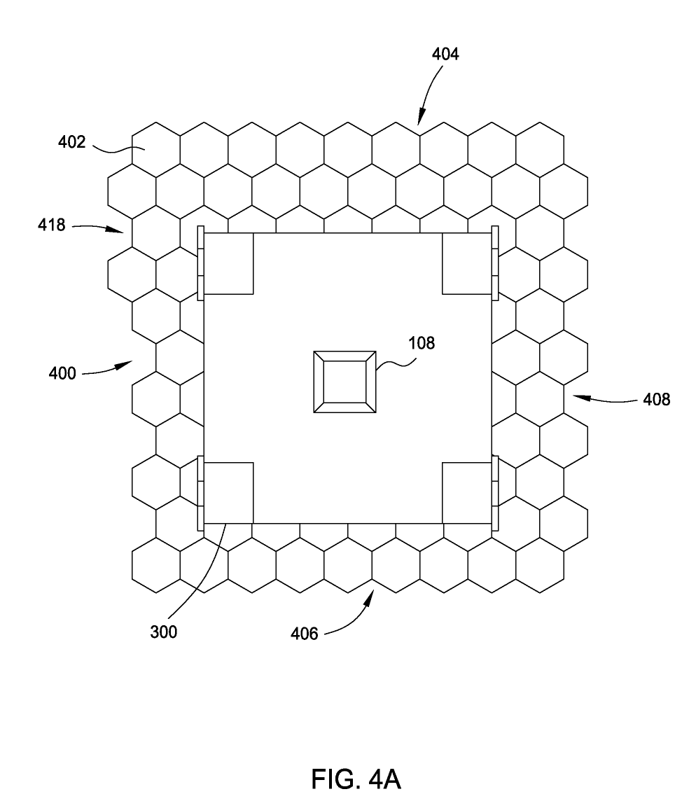

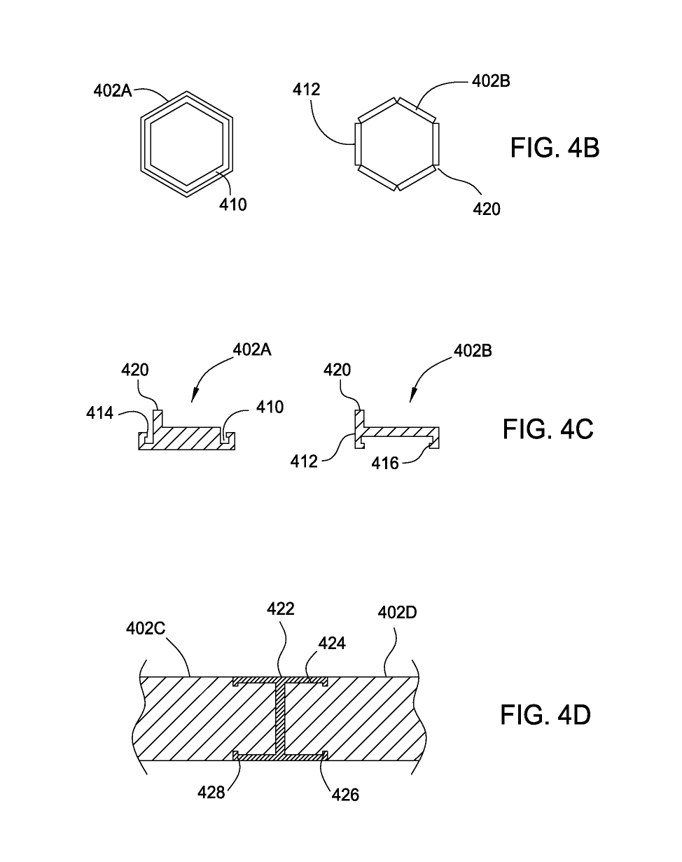

The pressure and volume of gas supplied to the thrusters 306 is chosen based on the load to be carried by the apparatus 300. For loads such as drilling rigs, the thrusters 306 will be sized to provide a total thrust of at least 1,000,000 pounds upward on the support structure 111. The support surface 110 of FIG. 1, FIG. 3, and FIG. 4A has a surface area of approximately 2500 sq-ft, so the support force distributed over the surface 110 results in a pressure of 2.8 psi. The thrusters 306 occupy a fraction of that area, for example about 10% of the total area of the support surface. Each thruster 306 thus maintains a pressure of about 30 psi to float a total load of about 1,000,000 pounds. Thruster units may be designed and specified in numbers to support any desired load capacity.

Power to the traction units is selected based on how much acceleration capability is needed for an embodiment. Frictional force due to the normal force of the load is canceled by air bearing, so power requirements for the traction units is greatly reduced. In the embodiments described herein for transporting a drill rig, each of the traction units is powered to generate a lateral thrust of about 2500 pounds. Four units together have a thrust of about 10,000 pounds.

The linear actuators 234 are normal force applicators for each traction unit 200. The normal force applied by each linear actuator 234 is selected to provide enough friction for the track 202 to provide 2500 pounds of lateral force. Depending on the coefficient of static friction between the track 202 and the surface contacting the track 202, the normal force applied to each track 202 may be between 100 pounds and 1000 pounds, for example about 500 pounds for each track 202.

The air bearing transport apparatus 102 of FIG. 1 may be used with a portable surface, if desired. FIG. 4A is a top view of a drilling system 400 that utilizes the air bearing transport apparatus 300 of FIG. 3. The apparatus 300 is disposed on a portable surface 418 that comprises a plurality of tiles 402. The tiles 402 are detachable, one from another, so that one tile may be moved from one part of the portable surface 418 to another part of the portable surface 418 to change the shape of the portable surface 418. The portable surface 418 is thus modular, and may be shaped in any desired way. In the embodiment of FIG. 4, the tiles 402 have a hexagonal shape, but any suitable shaped tile may be used that can effectively tile a plane. The tiles 402 of FIG. 4 have the same general shape, being all hexagonal, but tiles may be used that have different shapes suited to forming a portable surface. For example, square tiles may be used with octagonal tiles and triangular tiles may be used with hexagonal tiles. Hexagonal tiles may be useful for providing a portable surface that can bear large loads, because a hexagonal tiling does not feature long straight seams that can fold under load. Mixed shape tilings may also provide strong portable surfaces.

FIG. 4B is a top view of two tiles 402A and 402B shown in a spaced apart arrangement. Each of the tiles 402A and 402B has connecting features. The tile 402A has a trough feature 410 and the tile 402B has an extension feature 412 that mates with the trough feature 410 to connect the tiles 402A/B together. One of the connecting features 410/412 may be continuous around a perimeter of the tile 402A/B. In FIG. 4B, the trough feature 410 is continuous around the perimeter of the tile 402A. The extension feature 412 comprises a plurality of protrusions from each edge of the tile 402B separated by gaps at the vertices of the tile 402B. The gaps provide a means for the connection features 410/412 to engage so the tiles 402A/B attach together.

FIG. 4C shows the tiles 402A/B in cross-section. The trough feature 410 of the tile 402A, and the extension feature 412 of the tile 402B, are visible. The trough feature 410 has a protrusion 414 at an upper edge of the trough feature 410 that facilitates engagement with the extension feature 412 of the tile 402B. The extension feature 412 likewise has a protrusion 416 at a lower edge of the extension feature 412 that facilitates engagement with the trough feature 410 of the tile 402A. By positioning the extension feature 412 inside the trough feature 410 and moving the tiles 402A/B away from each other, the protrusions 414/416 engage and provide a linkage between the tiles 402A/B. In some embodiments, when the protrusions 414/416 are engaged, a gap may persist between the tiles 402A/B. If desired, this gap may be filed by inserting a filler member, which may be a tile lock. The filler member may be a hard rubber material shaped like a rod or dowel and sized to substantially fill the gap between the tiles. Using a pliable material like rubber allows stresses to be distributed across the portable surface through the filler members. Filling gaps between the tiles improves the air support characteristics of the portable surface for use with air bearing systems like the apparatus 300.

The tiles 402 typically have a thickness between about 3-6 inches, for example about 4 inches. The protrusions 414/416 typically extend less than 1 inch, for example 0.5-1.0 inches, and the gap remaining between the tiles 402A/B after engagement of the protrusions is typically about 0.6-1.1 inches, allowing a small clearance of 0.1 inches for insertion of the extension feature 412 into the trough feature 410. The trough feature 410 may have a minimum depth of 1-4 inches. The tile 402A, featuring the trough feature 410, has a flat bottom surface, such that the trough feature 410 forms a trench in the upper surface of the tile 402A.

The tiles 402A/B may have an edge barrier 420 for containing liquids on the portable surface 418. The edge barrier 420 may be provided on any number of sides, up to all six sides of the hexagonal tile 402, to provide flexibility in shaping the portable surface 418 and locating a containment area on the portable surface 418. At a drilling site, for example, edge barrier tiles may be used that have one, two, three, four, five, and six edge barriers depending on the needs of the portable surface. The edge barriers of neighboring tiles may be sealed using any convenient means. A sealing tape may be applied to the gap between two edge barriers, or a cover may be applied over the two adjacent edge barriers to cover the gap. The cover may be a geomembrane material or a rigid or semi-rigid clip that fits over the edge barriers to seal the gap. The gap fill members may also feature raised barrier features that protrude above the portable surface 418 to enhance the barrier features of the portable surface 418. Tiles with edge barriers may be used to provide more than one containment barrier on the portable surface 418, if desired. For example, tiles with edge barriers may be deployed to provide an inner containment area surrounded by an outer containment area. The inner containment area may be localized around a spill risk zone, and the outer containment area may surround the inner containment area to provide secondary containment in the event containment is lost in the inner containment zone. In an embodiment where the drilling rig 108 and the air bearing transport system 300 are transported from drill site to drill site using the portable surface 418, a containment aisle may be constructed along the path of the drill sites.

The tiles 402 are generally sized according to the needs of particular embodiments. In the embodiment of FIG. 4, in which the drilling rig 108 and sub base 106 are disposed on the support surface 110 for transportation, the hexagonal tiles 402 have a dimension of about 4 feet between opposite vertices. The tiles may be made from any convenient and suitable material. For heavy load applications, such as the embodiment of FIG. 4, the tiles 402 may be a strong polymeric material, such as polypropylene or polystyrene. The tiles 402 are typically molded, and in the embodiment of FIG. 4 the tiles 402 have a thickness of about 3 inches. The thickness of the tiles 402 is typically at least 2 inches, for example between about 2 inches and about 4 inches.

FIG. 4D is a cross-sectional view of two tiles 402C/D in a linking arrangement according to another embodiment. The tiles 402C/D are joined by a rail 422, which may be a locking rail, that has a recess on each side for engaging a tile 402. Each of the tiles 402C/D has an edge 424 that is shaped to engaged with the rail 422. A protrusion 426 of each of the rails 402C/D engages with a groove 428 of the tile to lock the tiles 402C/D together with the rail 422. The locking mechanism of FIG. 4D distributes loads across the portable surface 400 because the rail 422 transmits stresses from one tile 402 to another.

In operation, the portable surface 400 may be used to dynamically pave an area for the air bearing transport apparatus 300 to traverse. If the air bearing transport apparatus 300 is to move in a particular direction, so that there is a leading edge 404 and a trailing edge 406 of the portable surface 418 according to the direction of motion of the apparatus 300, tiles 402 may be retrieved from the portable surface at, or behind, the trailing edge 406 of the portable surface 418 and deployed along the leading edge 404 of the portable surface 418 as the apparatus 300 moves. Thus, the portable surface may dynamically pave the area being traversed by the apparatus 300. If the apparatus 300 is to alter direction, for example by turning a corner, tiles may be deployed to the portable surface along a lateral edge 408 in the intended direction to extend the portable surface in the new direction.

The tiles 402 may be coated with a convenient material to harden, insulate, smooth, or otherwise adapt the contact surface of the portable surface 400 according to any desired characteristics. In one embodiment, the tiles may be coated with metal sheeting to absorb impacts from any dropped tools or equipment. The metal sheeting may be adhered to the tiles using an adhesive, or may be melt-welded to the tiles by applying the metal sheeting to the tile, heating the metal sheeting to soften or melt the polymer of the tile, and allowing the polymer to re-freeze to the metal sheeting. The tiles may also be coated with heat and chemical resistant material.

It should be noted that an air bearing transport system such as the apparatus 102 or the apparatus 300 may be used to transport virtually anything. In one notable example, a first air bearing transport apparatus may be used to transport a drill rig, as shown in FIG. 1, while a second air bearing transport apparatus is used to transport a support unit for the drill rig, such as a fluids preparation unit, a remediation unit, a power unit, or a control unit. The second air bearing transport apparatus will maintain the support unit in useful proximity to the drill rig as the drill rig is transported. In this way, the drill rig and the support unit may be conveniently transported across an entire drill site. Multiple air bearing transport apparatus may be used to conveniently transport all the usual support units for a drill rig listed above, so that the entire drilling operation may be moved together across the drill site.

Finally, the movements of the air bearing transport apparatus 102 or 300 may be controlled by a controller. A computer on board the air bearing transport apparatus 102 may activate and control air flow and individual normal force applicators, rotational actuators, and drive rotors to provide easy operation. Controllers for multiple air bearing transport apparatus may be coordinated, if desired, to synchronize movement of connected or coordinated cargos.

While the foregoing is directed to embodiments of the invention, other and further embodiments of the invention may be devised without departing from the basic scope thereof.

What is claimed is:

1. An air bearing transport system, comprising:
a support structure having a support surface;
a plurality of thrusters coupled to the support structure, each thruster producing a gas flow in a direction substantially perpendicular to the support surface; and
a plurality of traction units rotatably coupled to a peripheral region of the support structure, each traction unit comprising a track member.

2. The air bearing transport system of claim 1, wherein each of the plurality of traction units comprises a normal force applicator.

3. The air bearing transport system of claim 2, wherein each of the plurality of traction units is slidably coupled to the support structure by a slide plate coupled to a support member.

4. The air bearing transport system of claim 3, further comprising a force applicator coupled between the slide plate and the support member.

5. The air bearing transport system of claim 4, further comprising a rotation assembly coupling the track member to the slide plate.

6. The air bearing transport system of claim 5, wherein the rotation assembly comprises a rotary actuator coupled to the slide plate, and a motor support coupled to the rotary actuator and the track member.

7. The air bearing transport system of claim 6, wherein the track member comprises a motor and the motor support is disposed around the motor.

8. The air bearing transport system of claim 7, wherein the plurality of thrusters comprises a first thruster group and a second thruster group, each of the first and second thruster groups being aligned along an axis of the support structure.

9. The air bearing transport system of claim 8, wherein the plurality of thrusters produces a force of at least one million pounds on the support surface.

10. A drilling rig disposed on the air bearing transport system of claim 9.

11. The air bearing transport system of claim 1, wherein the track member of each traction unit is a dual track member.

12. A drilling system, comprising:
a drilling rig and a sub base, the sub base disposed on an air bearing transport apparatus, the air bearing transport apparatus comprising:
a support structure having a support surface;
a plurality of thrusters coupled to the support structure, each thruster producing a gas flow in a direction substantially perpendicular to the support surface; and
a plurality of traction units rotatably coupled to a peripheral region of the support structure, each traction unit comprising a track member.

13. The drilling system of claim 12, wherein each traction unit further comprises a normal force applicator.

14. The drilling system of claim 13, wherein each traction unit further comprises a rotational assembly.

15. The drilling system of claim 14, further comprising a portable surface over which the air bearing transport apparatus is disposed.

16. The drilling system of claim 15, wherein the portable surface comprises a plurality of interlocking hexagonal tiles.

17. The drilling system of claim 16, wherein the plurality of interlocking hexagonal tiles comprises a plurality of interlocking hexagonal tiles with one or more edge barriers.

18. The drilling system of claim 13, wherein the track member of each traction unit is a dual track member.

19. The drilling system of claim 18, wherein the plurality of traction units consists essentially of two traction units disposed at diagonally opposite locations of the support structure.
